(19) United States
(12) Patent Application Publication
(10) Pub. No.: US 2020/0013346 A1
(43) Pub. Date: Jan. 9, 2020

(54) DISPLAY APPARATUS AND METHOD OF DRIVING THE SAME

(71) Applicant: Samsung Display Co., Ltd., Yongin-si (KR)

(72) Inventors: Seokha HONG, Seoul (KR); Jae Sung BAE, Suwon-si (KR); Jae Hoon LEE, Seoul (KR); Jai-Hyun KOH, Yongin-si (KR); Hoi Sik MOON, Hwaseong-si (KR); Namjae LIM, Gwacheon-si (KR)

(21) Appl. No.: 16/505,464

(22) Filed: Jul. 8, 2019

(30) Foreign Application Priority Data
Jul. 9, 2018 (KR) 10-2018-0079648

(51) Int. Cl. G09G 3/34; G09G 3/36; F21V 8/00

(52) U.S. Cl. CPC G09G 3/342; G02B 6/0053; G09G 3/3607

(57) ABSTRACT

A display apparatus includes: a local dimmer configured to generate a dimming signal representing a degree of dimming of a light source block based on input image data; a luminance compensator configured to compensate luminance of the input image data based on the input image data and the dimming signal; a display panel configured to display an image based on the compensated input image data; and a light source configured to provide light to the display panel based on the dimming signal, wherein the luminance compensator is configured to compensate the luminance of the input image data using a gain varied according to a grayscale value of the input image data.

### CROSS-REFERENCE TO RELATED APPLICATION

This application claims priority to and the benefit of Korean Patent Application No. 10-2018-0079648, filed on Jul. 9, 2018 in the Korean Intellectual Property Office KIPO, the entire content of which is herein incorporated by reference.

### BACKGROUND

### 1. Field

Aspects of some example embodiments of the present inventive concept relate to a display apparatus and a method of driving the display apparatus.

### 2. Description of the Related Art

In a local dimming method, a degree of turning on of a light source may be determined based on a luminance of a block of input image data to reduce a power consumption of a display apparatus.

When the display apparatus is driven in the local dimming method, a total luminance of a display panel is decreased. The input image data may be adjusted to increase the brightness in order to compensate for the decreased luminance. When the input image data is compensated, the input image data may be inversely compensated or overcompensated in the low grayscale range so that the display quality of the low grayscale range may be deteriorated.

The Background section of the present Specification includes information that is intended to provide context to example embodiments, and the information in the present Background section does not necessarily constitute prior art.

### SUMMARY

Aspects of some example embodiments of the present inventive concept relate to a display apparatus and a method of driving the display apparatus. For example, some example embodiments of the present inventive concept relate to a display apparatus with enhanced display quality in a low grayscale range by utilizing a local dimming method and a method of driving the display apparatus.

Some example embodiments of the present inventive concept provide a display apparatus compensating input image data using gains varied according to grayscale values to enhance a display quality of the image in a low grayscale range in a local dimming method.

Some example embodiments of the present inventive concept also provide a method of driving the display apparatus.

In an example embodiment of a display apparatus according to the present inventive concept, the display apparatus includes a local dimming part, a luminance compensator, a display panel and a light source part. The local dimming part is configured to generate a dimming signal representing a degree of dimming of a light source block based on input image data. The luminance compensator is configured to compensate luminance of the input image data based on the input image data and the dimming signal. The display panel is configured to display an image based on the compensated input image data. The light source part is configured to provide light to the display panel based on the dimming signal. The luminance compensator is configured to compensate the luminance of the input image data using a gain varied according to a grayscale value of the input image data.

In an example embodiment, the luminance compensator may be configured not to compensate the luminance of the input image data in a first grayscale range. The luminance compensator may be configured to compensate the luminance of the input image data using a fixed gain in a second grayscale range. The luminance compensator may be configured to compensate the luminance of the input image data using a varied gain which increases as the grayscale value of the input image data increases in a third grayscale range.

In an example embodiment, the third grayscale range may be between the first grayscale range and the second grayscale range.

In an example embodiment, a gain for the first grayscale range may be one. The fixed gain for the second grayscale range may be inversely proportional to the degree of dimming of the light source block.

In an example embodiment, the varied gain for the third grayscale range may increase from one to the fixed gain for the second grayscale range.

In an example embodiment, the first grayscale range may be determined by a cross point of a luminance curve of the input image data to which a local dimming method is applied and a target gamma curve.

In an example embodiment, when the degree of dimming of the light source block is fixed, the gain may increase as the grayscale value of the input image data increases.

In an example embodiment, when the grayscale of the input image data is fixed, the gain may decrease as the degree of dimming of the light source block increases.

In an example embodiment, a width of the first grayscale range may increase as the degree of dimming of the light source block increases.

In an example embodiment, the local dimming part may be configured to determine the degree of dimming of the light source block using a maximum value of a grayscale data in a display block corresponding to the light source block and an average value of the grayscale data in the display block corresponding to the light source block.

In an example embodiment, the luminance compensator may include a spread part configured to apply an interference value between the light source blocks to the dimming signal based on a light source luminance profile.

In an example embodiment, the luminance compensator may further include an interpolation part configured to interpolate the degree of the diming of the light source block to which the interference value is applied to generate a dimming value in a unit of a pixel of the display panel.

In an example embodiment, the luminance compensator may further include a local pixel compensator configured to compensate the luminance of the input image data based on a grayscale value of the input image data in the unit of the pixel and the dimming value in the unit of the pixel.

In an example embodiment, the display apparatus may further include a gate driver configured to output a gate signal to the display panel, a data driver configured to output a data voltage to the display panel and a driving controller configured to control a driving timing of the gate driver and a driving timing of the data driver. The driving controller may include the local dimming part and the luminance compensator.

In an example embodiment, the display apparatus may further include a gate driver configured to output a gate signal to the display panel, a data driver configured to output a data voltage to the display panel, a driving controller configured to control a driving timing of the gate driver and a driving timing of the data driver and a host configured to provide the compensated input image data to the driving controller. The host may include the local dimming part and the luminance compensator.

In an example embodiment of a display apparatus according to the present inventive concept, the display apparatus includes a local dimming part, a luminance compensator, a display panel and a light source part. The local dimming part is configured to generate a dimming signal representing a degree of dimming of a light source block based on input image data. The luminance compensator is configured to compensate luminance of the input image data based on the input image data and the dimming signal. The display panel is configured to display an image based on the compensated input image data. The light source part is configured to provide light to the display panel based on the dimming signal. The local dimming part is configured to generate the dimming signal representing a light source luminance corresponding to a dimming representative value of the light source block in a normal grayscale range and a first light source luminance less than a second light source luminance which corresponds to the dimming representative value of the light source block in the low grayscale range.

In an example embodiment of a method of driving a display apparatus, the method includes generating a dimming signal representing a degree of dimming of a light source block based on input image data, compensating luminance of the input image data based on the input image data and the dimming signal to generate second input image data, providing light to a display panel based on the dimming signal, generating a data voltage based on the second input image data and outputting the data voltage to the display panel. The luminance of the input image data is compensated using a gain varied according to a grayscale value of the input image data.

In an example embodiment, the compensating the luminance of the input image data to generate the second input image data may include not compensating the luminance of the input image data in a first grayscale range, compensating the luminance of the input image data using a fixed gain in a second grayscale range and compensating the luminance of the input image data using a varied gain which increases as the grayscale value of the input image data increases in a third grayscale range.

In an example embodiment, the third grayscale range may be between the first grayscale range and the second grayscale range.

In an example embodiment, a gain for the first grayscale range may be one. The fixed gain for the second grayscale range may be inversely proportional to the degree of dimming of the light source block. The varied gain for the third grayscale range may increase from one to the fixed gain for the second grayscale range.

According to the display apparatus and the method of driving the display apparatus, the light source part is driven in the local dimming method according to the input image data so that a power consumption of the display apparatus may be reduced. In addition, the input image data may be compensated using the gains varied according to the grayscale values so that inverse compensation or overcompensation of the luminance of the image in the low grayscale range may be prevented or reduced. Thus, the display quality of the low grayscale range may be enhanced.

### BRIEF DESCRIPTION OF THE DRAWINGS

The above and other features and aspects of the present inventive concept will become more apparent by describing in more detail aspects of some example embodiments thereof with reference to the accompanying drawings, in which:

FIG. 1 is a block diagram illustrating a display apparatus according to an example embodiment of the present inventive concept;

FIG. 2 is a conceptual diagram illustrating display blocks of a display panel of FIG. 1;

FIG. 3 is a conceptual diagram illustrating light source blocks of a light source part of FIG. 1;

FIG. 4 is a block diagram illustrating a driving controller of FIG. 1;

FIG. 5 is a detailed block diagram illustrating the driving controller of FIG. 1;

FIG. 6 is a conceptual diagram illustrating an operation of a block representative value determining part of FIG. 5;

FIG. 7 is a graph illustrating an operation of a local pixel compensator in 50% dimming according to a comparative embodiment;

FIGS. 8A and 8B are tables illustrating an operation of a local pixel compensator of FIG. 5;

FIG. 9 is a graph illustrating an operation of the local pixel compensator of FIG. 5 in 50% dimming;

FIG. 10 is a graph illustrating an operation of the local pixel compensator of FIG. 5 in 30% dimming;

FIGS. 11A to 11F are conceptual diagrams illustrating sequential operations of the driving controller;

FIG. 12 is a graph illustrating a luminance of a light source according to a dimming representative value according to a comparative embodiment;

FIG. 13 is a graph illustrating a luminance of a light source according to a dimming representative value according to an example embodiment of the present inventive concept;

FIG. 14 is a block diagram illustrating a display apparatus according to an example embodiment of the present inventive concept; and

FIG. 15 is a block diagram illustrating a host of FIG. 14.

### DETAILED DESCRIPTION

Hereinafter, aspects of some example embodiments of the present inventive concept will be explained in more detail with reference to the accompanying drawings.

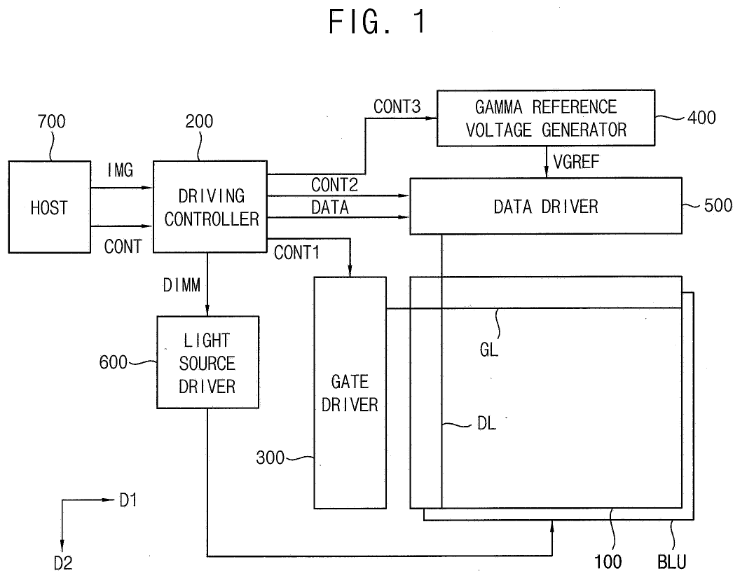

FIG. 1 is a block diagram illustrating a display apparatus according to an example embodiment of the present inventive concept.

Referring to FIG. 1, the display apparatus includes a display panel 100 and a display panel driver. The display panel driver includes a driving controller 200, a gate driver 300, a gamma reference voltage generator 400 and a data driver 500. The display apparatus may further include a light source part (or light source or light source circuit) BLU providing light to the display panel 100 and a light source driver 600 driving the light source part BLU. The display apparatus may further include a host 700 providing input image data IMG to the driving controller 200.

The display panel 100 includes a plurality of gate lines GL, a plurality of data lines DL and a plurality of pixels electrically connected to the gate lines GL and the data lines DL. The gate lines GL may extend in a first direction D1 and the data lines DL may extend in a second direction D2 crossing the first direction D1.

The display panel 100 may include a first base substrate on which the gate lines GL, the data lines DL, the pixels and switching elements are located, a second base substrate facing the first base substrate and including a common electrode and a liquid crystal layer located between the first base substrate and the second base substrate.

The driving controller 200 may receive the input image data IMG and an input control signal CONT from the host 700. For example, the input image data IMG may include red image data, green image data and blue image data. The input image data IMG may include white image data. The input image data IMG may include magenta image data, cyan image data, and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates a dimming signal DIMM to control a dimming operation of the light source part BLU based on the input image data IMG. The driving controller 200 outputs the dimming signal DIMM to the light source driver 600. The dimming signal DIMM may be a local dimming signal representing a degree of dimming of each light source blocks of the light source part BLU.

The gate driver 300 generates gate signals driving the gate lines GL in response to the first control signal CONT1 received from the driving controller 200. The gate driver 300 may output the gate signals to the gate lines GL.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an example embodiment, the gamma reference voltage generator 400 may be located in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

The light source driver 600 may receive the dimming signal DIMM from the driving controller 200. The light source driver 600 may convert the dimming signal DIMM into a light source driving signal. The light source driver 600 may output the light source driving signal to the light source part BLU.

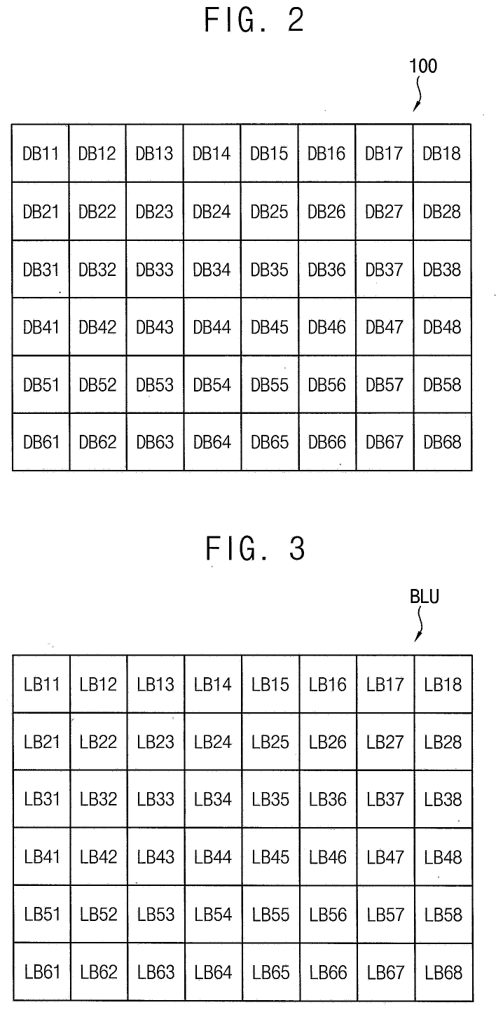

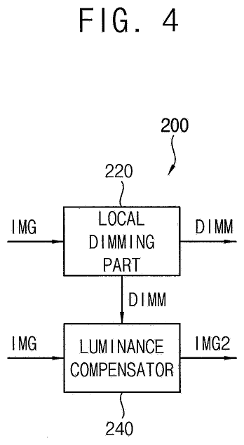

FIG. 2 is a conceptual diagram illustrating display blocks of the display panel 100 of FIG. 1. FIG. 3 is a conceptual diagram illustrating light source blocks of the light source part BLU of FIG. 1.

Referring to FIGS. 1 to 3, the display panel 100 may include a plurality of display blocks DB11 to DB68 for a local dimming operation. Although the display blocks DB11 to DB68 form a six by eight matrix in the present example embodiment, the present inventive concept is not limited thereto.

In addition, the light source part BLU may include a plurality of light source blocks LB11 to LB68 for the local dimming operation. Although the light source blocks LB11 to LB68 form a six by eight matrix in the present example embodiment, the present inventive concept is not limited thereto. In addition, although the display blocks DB11 to DB68 and the light source blocks LB11 to LB68 correspond to each other one by one in the present example embodiment, the present inventive concept is not limited thereto. Alternatively, the plural light source blocks may correspond to the single display block or the plural display blocks may correspond to the single light source block.

In the local dimming method, when the grayscale data of the image displayed on the display block is high, the degree of dimming of the light source block corresponding to the display block may be increased. On the other hand, when the grayscale data of the image displayed on the display block is low, the degree of dimming of the light source block corresponding to the display block may be decreased.

For example, when the degree of dimming of the light source block is decreased in the local dimming method, the image may have a luminance lower than a luminance curve of the grayscale value according to a target gamma value. Thus, the input image data IMG may be compensated such that the luminance of the input image data IMG is increased.

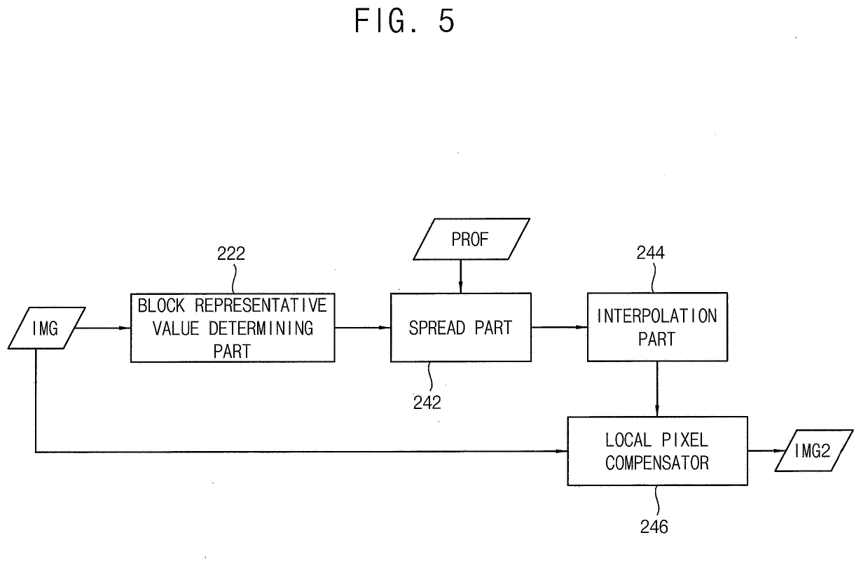

FIG. 4 is a block diagram illustrating the driving controller 200 of FIG. 1.

Referring to FIGS. 1 to 4, the driving controller 200 includes a local dimming part (or local dimmer or local dimming circuit) 220 and a luminance compensator 240. The local dimming part 220 generates the dimming signal DIMM representing a degree of dimming of the light source block based on the input image data IMG. The local dimming part 220 outputs the dimming signal DIMM to the light source driver 600. In addition, the local dimming part 220 outputs the dimming signal DIMM to the luminance compensator 240.

The luminance compensator 240 receives the input image data IMG and the dimming signal DIMM and compensates the luminance of the input image data IMG to generate second input image data IMG2.

The luminance compensator 240 may compensate the luminance of the input image data IMG using gains varied according to the grayscale values of the input image data IMG.

The driving controller 200 may further include an image compensator. The image compensator may compensate the grayscale value of the second input image data IMG2 and may rearrange the second input image data IMG2 in a format of the data driver 500 to generate the data signal DATA.

The image compensator may output the data signal DATA to the data driver 500.

For example, the image compensator may include an adaptive color correction part (or adaptive color corrector or adaptive color correction circuit) and a dynamic capacitance compensation part (or dynamic capacitance compensator or dynamic capacitance compensation circuit).

The adaptive color correction part receives the grayscale data of the second input image data IMG2 and operates an adaptive color correction (“ACC”). The adaptive color correction part may compensate the grayscale data using a gamma curve.

The dynamic capacitance compensation part operates a dynamic capacitance compensation (“DCC”). The dynamic capacitance compensation part compensates the grayscale data of present frame data using a previous frame data and the present frame data.

The driving controller 200 may further include a signal generator.

The signal generator receives the input control signal CONT. The signal generator generates the first control signal CONT1 to control a driving timing of the gate driver 300 and the second control signal CONT2 to control a driving timing of the data driver 500 based on the input control signal CONT and a driving frequency. The signal generator generates the third control signal CONT3 to control a driving timing of the gamma reference voltage generator 400 based on the input control signal CONT and a driving frequency.

The signal generator outputs the first control signal CONT1 to the gate driver 300, the second control signal CONT2 to the data driver 500 and the third control signal CONT3 to the gamma reference voltage generator 400.

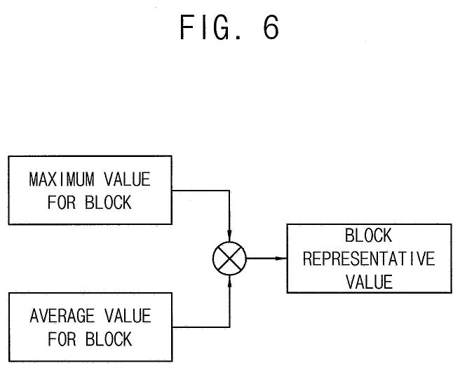

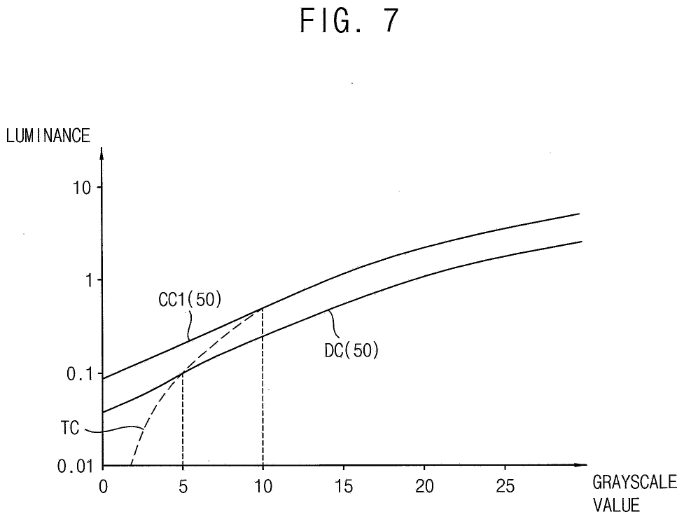

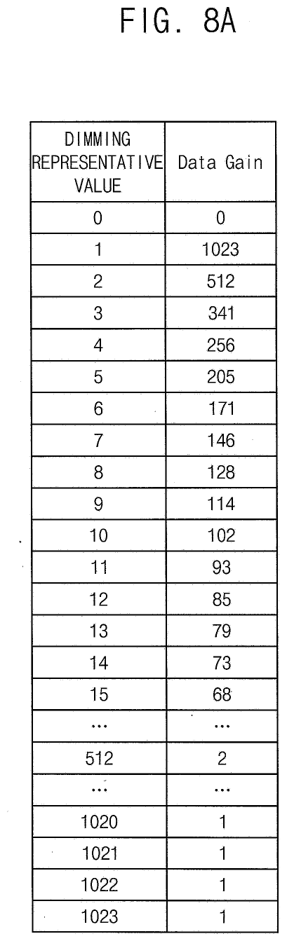

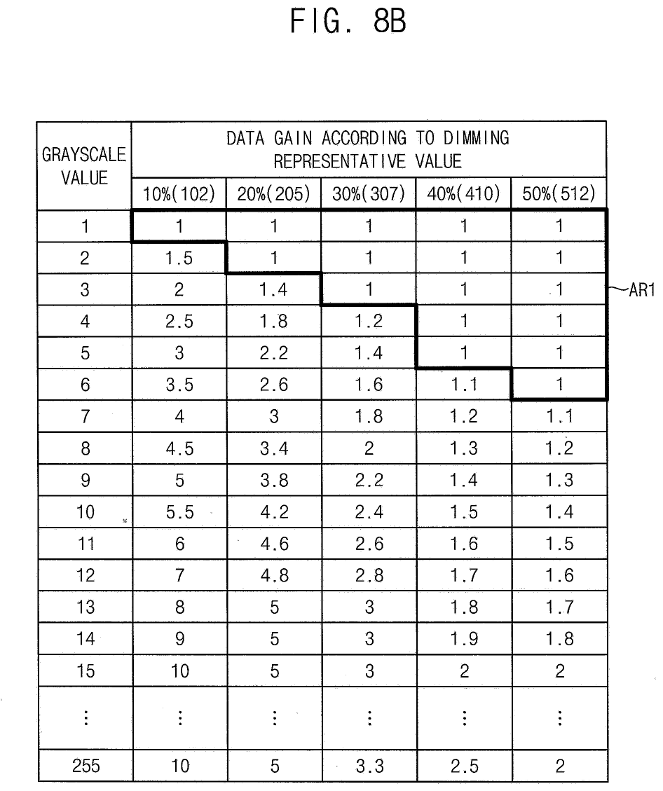

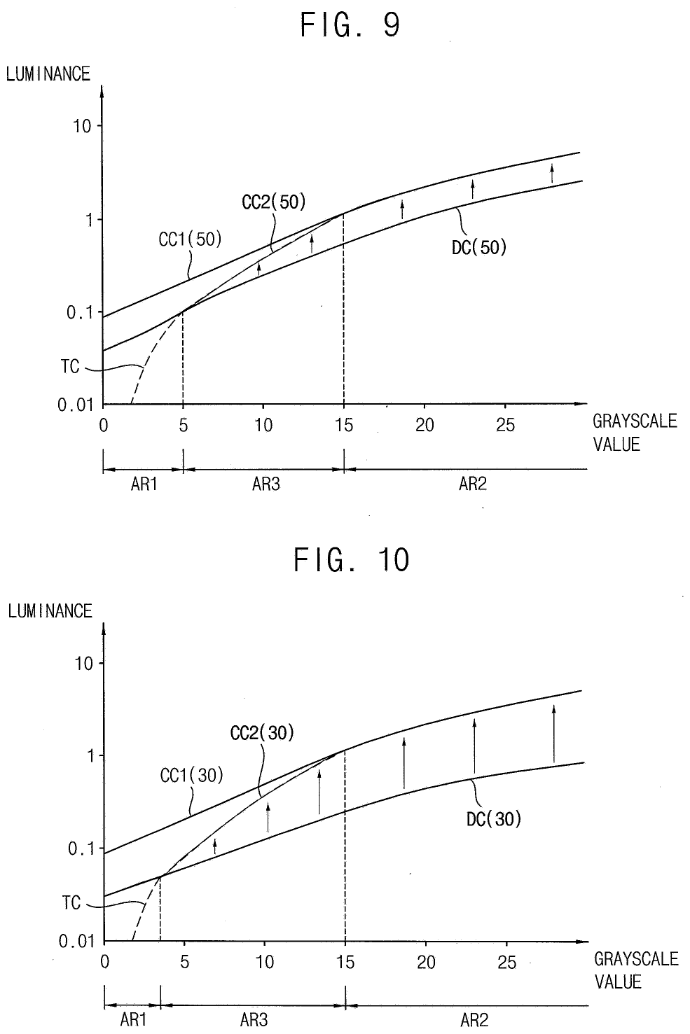

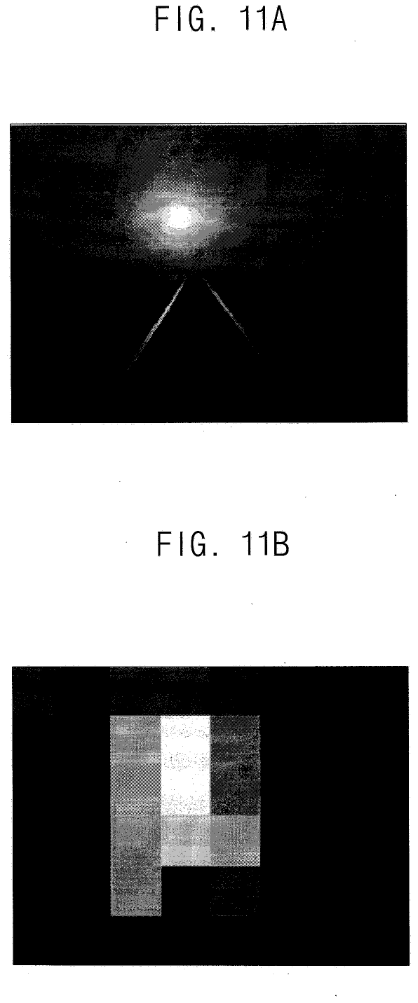

FIG. 5 is a detailed block diagram illustrating the driving controller 200 of FIG. 1. FIG. 6 is a conceptual diagram illustrating an operation of a block representative value determining part (or block representative value determiner or block representative value determining circuit) 222 of FIG. 5. FIG. 7 is a graph illustrating an operation of a local pixel compensator in 50% dimming according to a comparative embodiment. FIGS. 8A and 8B are tables illustrating an operation of a local pixel compensator 246 of FIG. 5. FIG. 9 is a graph illustrating an operation of the local pixel compensator 246 of FIG. 5 in 50% dimming. FIG. 10 is a graph illustrating an operation of the local pixel compensator 246 of FIG. 5 in 30% dimming.

Referring to FIGS. 1, 4 to 10, the local dimming part (or local dimmer or local dimming circuit) 220 may include a block representative value determining part 222. The block representative value determining part 222 may determine a representative value of the display block to determine a degree of dimming of the light source block.

The representative value of the display block may be determined using a maximum value of the grayscale data in the display block corresponding to the light source block and an average value of the grayscale data in the display block corresponding to the light source block.

For example, when the maximum value of the grayscale data in the display block is Max, the average value of the grayscale data in the display block is Mean and a blending parameter is a, the representative value RE of the display block may be determined using Equation 1.

RE=α×Max+(1−α)×Mean Equation 1

The block representative value determining part 222 may convert the representative value RE of the display block into a dimming representative value directly representing the degree of the dimming of the light source block. In FIG. 8A, the dimming representative value may have 1024 levels. When the dimming representative value is 0, the light source block may not be turned on. When the dimming representative value is 1023, the light source block may be maximally turned on. When the dimming representative value is 102, the light source block may be turned on in a 10% dimming value (also referred as a degree of dimming or a dimming ratio). When the dimming representative value is 205, the light source block may be turned on in a 20% dimming value. When the dimming representative value is 511, the light source block may be turned on in a 50% dimming value.

When the degree of dimming of the light source block is decreased in the local dimming method, the image may have a luminance lower than the luminance curve of the grayscale value according to the target gamma value. Thus, the input image data IMG may be compensated to increase the luminance of the input image data IMG.

The luminance compensator 240 may compensate the luminance of the input image data IMG using the gains varied according to the grayscale values of the input image data IMG. For example, the luminance compensator 240 may not compensate the luminance of the input image data IMG in a first grayscale range AR1. The luminance compensator 240 may compensate the luminance of the input image data IMG in a second grayscale range AR2 using a fixed gain. The luminance compensator 240 may compensate the luminance of the input image data IMG in a third grayscale range AR3 using a varied gain. Herein, the third grayscale range AR3 may be located between the first grayscale range AR1 and the second grayscale range AR2.

The luminance compensator 240 may include a spread part (or spreader or spread circuit) 242, an interpolation part (or interpolation circuit) 244 and a local pixel compensator 246. When the luminance compensator 240 compensates the luminance of a local pixel only using the dimming signal DIMM, accuracy of the luminance compensation may be low.

The spread part 242 may receive the degrees of dimming of the light source blocks from the block representative value determining part 222. The spread part 242 may receive a light source luminance profile PROF of the light source part BLU to increase the accuracy of the luminance compensation. The spread part 242 may apply interference values between the light source blocks to the degrees of dimming of the light source blocks based on the light source luminance profile PROF.

The spread part 242 may apply the interference values between the light source blocks to the degrees of dimming of the light source blocks using a point spread filter (“PSF”). Applying the interference values of the spread part 242 may be operated in a unit of the light source block or in a unit of a sampling block which is less than the light source block.

The interpolation part 244 may interpolate the degree of the diming of the light source block to which the interference values are applied to generate the dimming value in a unit of the pixel of the display panel 100.

The dimming information which is generated by the spread part 242 by applying the interference values does not correspond to the pixel so that the dimming information may be interpolated to generate dimming information of the pixel.

The interpolation part 244 may output the dimming information of the pixel to the local pixel compensator 246.

The local pixel compensator 246 compensates the luminance of the input image data IMG using the grayscale value of the pixel of the input image data IMG and the dimming value in the unit of the pixel of the display panel 100.

The local pixel compensator 246 may compensate the luminance of the input image data IMG using the gains varied according to the grayscale values of the input image data IMG to generate the second input image data IMG2.

FIG. 7 represents a case of 50% dimming, TC represents a target gamma curve, DC(50) represents the luminance curve having the decreased luminance by the local dimming method and CC1(50) represents the luminance curve compensated by a related art compensation method.

In the related art compensation method, the luminance curve DC(50) having the decreased luminance is compensated to approach the target gamma curve TC using a fixed gain. The compensated luminance curve CC1(50) generally coincides with the target gamma curve TC in a high grayscale range. However, the luminance curve CC1(50) may get farther from the target gamma curve TC than the luminance curve DC(50) before compensation in a grayscale range between zero to five. The luminance of the input image data IMG may be inversely compensated in the grayscale range between zero to five. In addition, the compensated luminance curve CC1(50) may exceed the target gamma curve TC in a grayscale range between five to ten. The luminance of the input image data IMG may be overcompensated in the grayscale range between five to ten.

In the present example embodiment, the local pixel compensator 246 may compensate the luminance of the input image data IMG using a data gain lookup table in FIG. 8B including the gains varied according to the degree of dimming and the grayscale value.

The local pixel compensator 246 may not compensate the luminance of the input image data IMG in the first grayscale range AR1. Thus, the gain may be one in the first grayscale range AR1.

The local pixel compensator 246 may compensate the luminance of the input image data IMG in the second grayscale range AR2 using the fixed gain. The fixed gain may not be varied according to the grayscale values. The fixed gain may have a value inversely proportional to the degree of dimming of the light source block. For example, when the dimming representative value is 102 (dimming ration of about 10%), the fixed gain may be ten. For example, when the dimming representative value is 205 (dimming ration of about 20%), the fixed gain may be five. For example, when the dimming representative value is 307 (dimming ration of about 30%), the fixed gain may be 3.3. For example, when the dimming representative value is 410 (dimming ration of about 40%), the fixed gain may be 2.5. For example, when the dimming representative value is 512 (dimming ration of about 50%), the fixed gain may be two. Multiplication of the dimming ratio (e.g. 10%, 20%, 30%, 40% and 50%) represented as the dimming representative value and the fixed gain may be one.

The local pixel compensator 246 may compensate the luminance of the input image data IMG in the third grayscale range AR3 using the varied gain. The varied gain may increase from one to the fixed gain as the grayscale value increases. For example, when the dimming representative value is 102 (dimming ration of about 10%), the varied gain may increase from one to ten as the grayscale value increases. For example, when the dimming representative value is 205 (dimming ration of about 20%), the varied gain may increase from one to five as the grayscale value increases. For example, when the dimming representative value is 307 (dimming ration of about 30%), the varied gain may increase from one to 3.3 as the grayscale value increases. For example, when the dimming representative value is 410 (dimming ration of about 40%), the varied gain may increase from one to 2.5 as the grayscale value increases. For example, when the dimming representative value is 512 (dimming ration of about 50%), the varied gain may increase from one to two as the grayscale value increases.

When the degree of dimming of the light source block is fixed, the gain may increase as the grayscale value of the input image data IMG increases. As shown in FIG. 8B, the gain may increase from one to 3.3 for the dimming ratio of 30%.

When the grayscale of the input image data IMG is fixed, the gain may decrease as the degree of dimming of the light source block increases. As shown in FIG. 8B, the gain may decrease from three to one for the grayscale value of 5.

In addition, a width of the first grayscale range AR1 may increase as the degree of dimming of the light source block increases. As shown in FIG. 8B, the first grayscale range AR1 only includes the grayscale value of one for the dimming ratio of 10%. The first grayscale range AR1 includes the grayscale values from one to three for the dimming ratio of 30%. The first grayscale range AR1 includes the grayscale values from one to six for the dimming ratio of 50%.

In FIGS. 9 and 10, the first grayscale range AR1 may be determined by a cross point of the luminance curves DC(50) and DC(30) of the input image data IMG to which the local dimming method is applied and the target gamma curve TC.

FIG. 9 represents a case of 50% dimming, TC represents the target gamma curve, DC(50) represents the luminance curve having the decreased luminance by the local dimming method, CC1(50) represents the luminance curve compensated by the related art compensation method and CC2(50) represents the luminance curve compensated by the compensation method of the present example embodiment.

In the compensation method of the present example embodiment, the luminance of the input image data IMG is not compensated in the first grayscale range AR1 (e.g. the grayscale values of zero to five). Thus, the luminance curve CC2(50) coincides with the luminance curve DC(50) before compensation in the first grayscale range AR1 so that the luminance curve CC2(50) may not get farther from the target gamma curve TC than the luminance curve DC(50) before compensation in the first grayscale range AR1. The luminance of the input image data IMG may not be inversely compensated in the first grayscale range AR1.

The luminance of the input image data IMG is compensated using the varied gain, which gradually increases as the grayscale value increases, in the third grayscale range AR3 (e.g. the grayscale values of five to fifteen). Thus, the luminance curve CC2(50) coincides with the target gamma curve TC in the third grayscale range AR3 so that the luminance curve CC2(50) may not exceed the target gamma curve TC in the third grayscale range AR3. The luminance of the input image data IMG may not be overcompensated in the third grayscale range AR3.

The luminance of the input image data IMG is compensated using the fixed gain in the second grayscale range AR2 (e.g. the grayscale values of fifteen to 255). The compensated luminance curve CC2(50) generally coincides with the target gamma curve TC in the second grayscale range AR2. The dimming ratio is 50% in the present example embodiment so that the fixed gain may be two.

FIG. 10 represents a case of 30% dimming, TC represents the target gamma curve, DC(30) represents the luminance curve having the decreased luminance by the local dimming method, CC1(30) represents the luminance curve compensated by the related art compensation method and CC2(30) represents the luminance curve compensated by the compensation method of the present example embodiment.

In the compensation method of the present example embodiment, the luminance of the input image data IMG is not compensated in the first grayscale range AR1 (e.g. the grayscale values of zero to four). Thus, the luminance curve CC2(30) coincides with the luminance curve DC(30) before compensation in the first grayscale range AR1 so that the luminance curve CC2(30) may not get farther from the target gamma curve TC than the luminance curve DC(30) before compensation in the first grayscale range AR1. The luminance of the input image data IMG may not be inversely compensated in the first grayscale range AR1.

The first grayscale range AR1 may be determined by the cross point of the luminance curves DC(50) and DC(30) of the input image data IMG to which the local dimming method is applied and the target gamma curve TC. Thus, the width of the first grayscale range AR1 in FIG. 10 may be less than the width of the first grayscale range AR1 in FIG. 9.

The luminance of the input image data IMG is compensated using the varied gain, which gradually increases as the grayscale value increases, in the third grayscale range AR3 (e.g. the grayscale values of four to fifteen). Thus, the luminance curve CC2(30) coincides with the target gamma curve TC in the third grayscale range AR3 so that the luminance curve CC2(30) may not exceed the target gamma curve TC in the third grayscale range AR3. The luminance of the input image data IMG may not be overcompensated in the third grayscale range AR3.

The luminance of the input image data IMG is compensated using the fixed gain in the second grayscale range AR2 (e.g. the grayscale values of fifteen to 255). The compensated luminance curve CC2(30) generally coincides with the target gamma curve TC in the second grayscale range AR2. The dimming ratio is 30% in the present example embodiment so that the fixed gain may be 3.3.

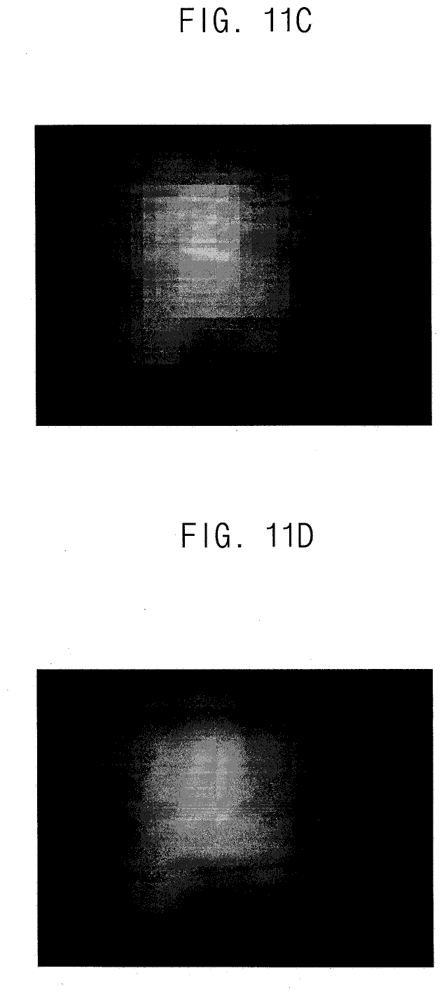

FIGS. 11A to 11F are conceptual diagrams illustrating sequential operations of the driving controller 200.

FIG. 11A represents the image displayed by the input image data IMG.

FIG. 11B represents the image of the input image data IMG representing the degrees of dimming of the light source blocks generated by the local dimming part 220. The dimming signal DIMM determined by the local dimming part 220 may have a resolution of the light source block of the light source part BLU.

FIG. 11C represents the image of the input image data IMG representing the degrees of dimming of the light source blocks to which the interference values between the light source blocks are applied based on the light source luminance profile PROF generated by the spread part 242. The dimming signal determined by the spread part 242 may have a resolution of the light source block of the light source part BLU or a resolution of the sampling block which is less than the light source block.

FIG. 11D represents the image of the input image data IMG representing the dimming value of a unit of the pixel of the display panel 100 generated by the interpolation part 244.

FIG. 11E represents the image of the input image data IMG to which the related art compensation method of FIG. 7 is applied. The luminance of the input image data IMG is compensated using the fixed gain even in the low grayscale range so that the image in the low grayscale range may be inversely compensated or overcompensated. Thus, a horizontal line of a picture is not shown in area A and area B of FIG. 11E.

FIG. 11F represents the image of the input image data IMG to which the compensation method of the present example embodiment is applied. As shown in FIGS. 9 and 10, the luminance of the input image data IMG is not compensated in the first grayscale range AR1 and the luminance of the input image data IMG is compensated using the varied gain in the third grayscale range AR3 so that the inverse compensation and the overcompensation of the image of the low grayscale range may be prevented or reduced.

According to the present example embodiment, the light source part BLU is driven in the local dimming method according to the input image data IMG so that a power consumption of the display apparatus may be reduced. In addition, the input image data IMG may be compensated using the gains varied according to the grayscale values so that inverse compensation or overcompensation of the luminance of the image in the low grayscale range may be prevented or reduced. Thus, the display quality of the image in the low grayscale range may be enhanced.

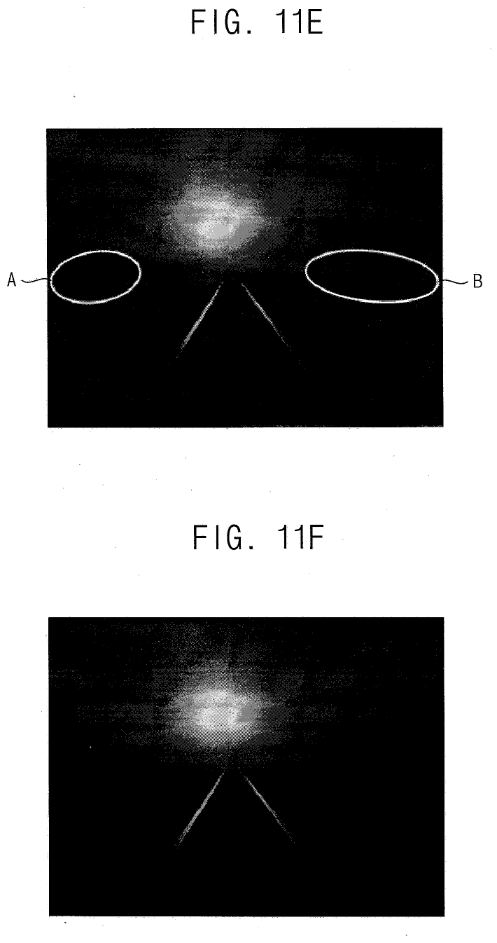

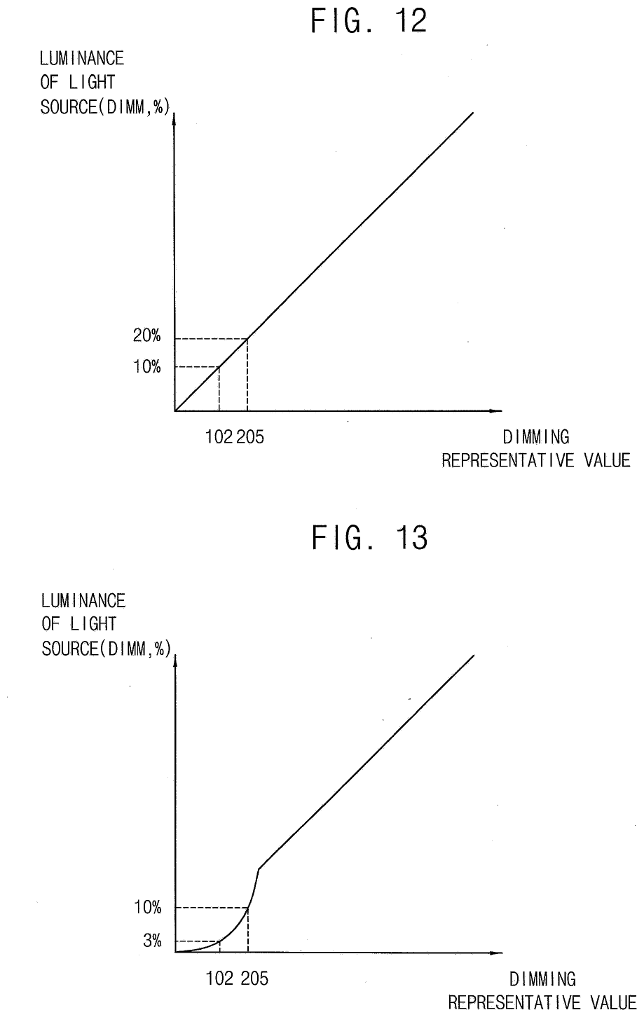

FIG. 12 is a graph illustrating a luminance of a light source according to a dimming representative value according to a comparative embodiment. FIG. 13 is a graph illustrating a luminance of a light source according to a dimming representative value according to an example embodiment of the present inventive concept.

The display apparatus and the method of driving the display apparatus according to the present example embodiment is substantially the same as the display apparatus and the method of driving the display apparatus of the previous example embodiment explained referring to FIGS. 1 to 11F except that the luminance of the light source part is directly compensated instead of compensating the luminance of the input image data. Thus, the same reference numerals will be used to refer to the same or like parts as those described in the previous example embodiment of FIGS. 1 to 11F and any repetitive explanation concerning the above elements will be omitted.

Referring to FIGS. 12 and 13, the display apparatus includes a display panel 100 and a display panel driver. The display panel driver includes a driving controller 200, a gate driver 300, a gamma reference voltage generator 400 and a data driver 500. The display apparatus may further include a light source part BLU providing light to the display panel 100 and a light source driver 600 driving the light source part BLU. The display apparatus may further include a host 700 providing input image data IMG to the driving controller 200.

As shown in FIG. 7, when the luminance of the low grayscale range (e.g. the grayscale values of zero to ten) and a normal grayscale range (e.g. the grayscale values greater than ten) is compensated using the fixed gain, the luminance of the low grayscale range may be inversely compensated or overcompensated.

To solve the above mentioned problem, the luminance of the light source part BLU may be directly decreased corresponding to the low grayscale range in the present example embodiment. Herein, the luminance compensator 240 may compensate the luminance of the input image data IMG using the fixed grayscale regardless of the grayscale value of the input image data IMG.

The local dimming part 220 may generate the dimming signal DIMM representing a light source luminance corresponding to a dimming representative value of a light source block in the normal grayscale range and a light source luminance (FIG. 13) less than a light source luminance (FIG. 12) corresponding to a dimming representative value of a light source block in the low grayscale range.

FIG. 12 represents an operation of a related art local dimming part. For example, when the dimming representative value of the light source block is 102, the related art local dimming part may turn on the light source block in the dimming ratio of 10%. For example, when the dimming representative value of the light source block is 205, the related art local dimming part may turn on the light source block in the dimming ratio of 20%.

FIG. 13 represents an operation of the local dimming part 220 of the present example embodiment. For example, when the dimming representative value of the light source block is 102, the local dimming part 220 may turn on the light source block in the dimming ratio of 3% which is less than 10%. For example, when the dimming representative value of the light source block is 205, the local dimming part 220 may turn on the light source block in the dimming ratio of 10% which is less than 20%.

According to the present example embodiment, the light source part BLU is driven in the local dimming method according to the input image data IMG so that a power consumption of the display apparatus may be reduced. In addition, the light source part BLU is turned on in the light source luminance less than the light source luminance which corresponds to the dimming representative value of the light source part BLU in the low grayscale range. Thus, the display quality of the image in the low grayscale range may be enhanced.

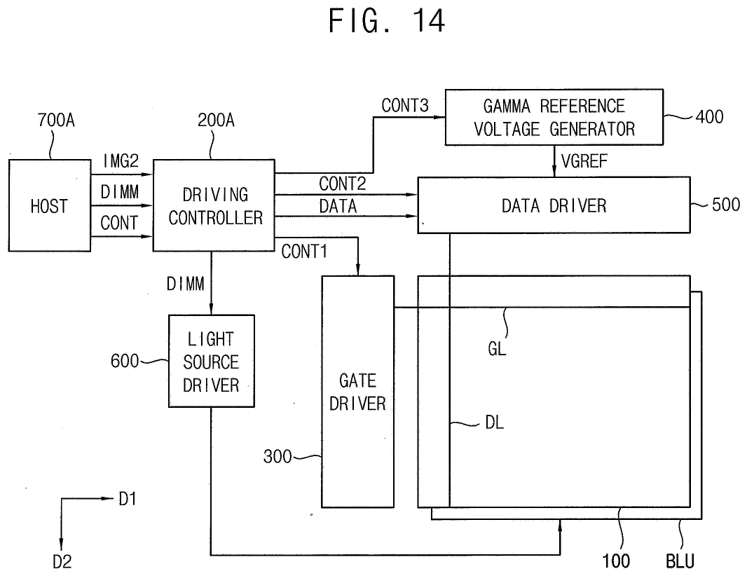

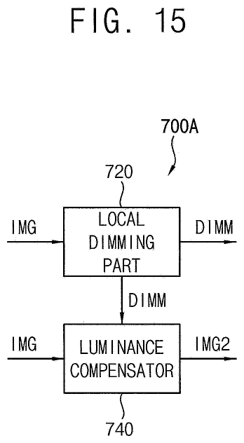

FIG. 14 is a block diagram illustrating a display apparatus according to an example embodiment of the present inventive concept. FIG. 15 is a block diagram illustrating a host 700A of FIG. 14.

The display apparatus and the method of driving the display apparatus according to the present example embodiment is substantially the same as the display apparatus and the method of driving the display apparatus of the previous example embodiment explained referring to FIGS. 1 to 11F except for the position of the local dimming part and the luminance compensator. Thus, the same reference numerals will be used to refer to the same or like parts as those described in the previous example embodiment of FIGS. 1 to 11F and any repetitive explanation concerning the above elements will be omitted.

Referring to FIGS. 14 and 15, the display apparatus includes a display panel 100 and a display panel driver. The display panel driver includes a driving controller 200A, a gate driver 300, a gamma reference voltage generator 400 and a data driver 500. The display apparatus may further include a light source part BLU providing light to the display panel 100 and a light source driver 600 driving the light source part BLU. The display apparatus may further include a host 700A providing the compensated input image data to the driving controller 200A. In the present example embodiment, the host 700A may output second input image data IMG2 having compensated luminance to the driving controller 200A.

The host 700A includes a local dimming part 720 and a luminance compensator 740. The local dimming part 720 generates a dimming signal DIMM representing a degree of dimming of the light source block based on the input image data IMG. The dimming signal DIMM may be a local dimming signal representing a degree of dimming of each light source blocks of the light source part BLU.

The local dimming part 720 outputs the dimming signal DIMM to the driving controller 200A. Alternatively, the local dimming part 720 may output the dimming signal DIMM to the light source driver 600. In addition, the local dimming part 720 outputs the dimming signal DIMM to the luminance compensator 740.

The luminance compensator 740 receives the input image data IMG and the dimming signal DIMM and compensates the luminance of the input image data IMG to generate second input image data IMG2.

The luminance compensator 740 may compensate the luminance of the input image data IMG using the gains varied according to the grayscale values of the input image data IMG. For example, the luminance compensator 740 may not compensate the luminance of the input image data IMG in a first grayscale range AR1. The luminance compensator 240 may compensate the luminance of the input image data IMG in a second grayscale range AR2 using a fixed gain. The luminance compensator 740 may compensate the luminance of the input image data IMG in a third grayscale range AR3 using a varied gain. Herein, the third grayscale range AR3 may be located between the first grayscale range AR1 and the second grayscale range AR2.

The driving controller 200A may generate the data signal DATA based on the second input image data IMG2. The driving controller 200A may output the data signal DATA to the data driver 500.

The driving controller 200A may output the dimming signal DIMM received from the local dimming part 720 to the light source driver 600.

According to the present example embodiment, the light source part BLU is driven in the local dimming method according to the input image data IMG so that a power consumption of the display apparatus may be reduced. In addition, the input image data IMG may be compensated using the gains varied according to the grayscale values so that inverse compensation or overcompensation of the luminance of the image in the low grayscale range may be prevented or reduced. Thus, the display quality of the image in the low grayscale range may be enhanced.

According to some example embodiments of the present inventive concept as explained above, the power consumption of the display apparatus may be reduced and the display quality of the image in the low grayscale range may be enhanced.

The foregoing is illustrative of the present inventive concept and is not to be construed as limiting thereof. Although a few example embodiments of the present inventive concept have been described, those skilled in the art will readily appreciate that many modifications are possible in the example embodiments without materially departing from the novel teachings and aspects of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific example embodiments disclosed, and that modifications to the disclosed example embodiments, as well as other example embodiments, are intended to be included within the scope of the appended claims. The present inventive concept is defined by the following claims, with equivalents of the claims to be included therein.

What is claimed is:

1. A display apparatus comprising:
a local dimmer configured to generate a dimming signal representing a degree of dimming of a light source block based on input image data;
a luminance compensator configured to compensate luminance of the input image data based on the input image data and the dimming signal;
a display panel configured to display an image based on the compensated input image data; and
a light source configured to provide light to the display panel based on the dimming signal,
wherein the luminance compensator is configured to compensate the luminance of the input image data using a gain varied according to a grayscale value of the input image data.

2. The display apparatus of claim 1, wherein the luminance compensator is configured not to compensate the luminance of the input image data in a first grayscale range,
wherein the luminance compensator is configured to compensate the luminance of the input image data using a fixed gain in a second grayscale range, and
wherein the luminance compensator is configured to compensate the luminance of the input image data using a varied gain which increases as the grayscale value of the input image data increases in a third grayscale range.

3. The display apparatus of claim 2, wherein the third grayscale range is between the first grayscale range and the second grayscale range.

4. The display apparatus of claim 2, wherein a gain for the first grayscale range is one, and
wherein the fixed gain for the second grayscale range is inversely proportional to the degree of dimming of the light source block.

5. The display apparatus of claim 4, wherein the varied gain for the third grayscale range increases from one to the fixed gain for the second grayscale range.

6. The display apparatus of claim 2, wherein the first grayscale range is determined by a cross point of a luminance curve of the input image data to which a local dimming method is applied and a target gamma curve.

7. The display apparatus of claim 1, wherein when the degree of dimming of the light source block is fixed, the gain increases as the grayscale value of the input image data increases.

8. The display apparatus of claim 2, wherein when the grayscale value of the input image data is fixed, the gain decreases as the degree of dimming of the light source block increases.

9. The display apparatus of claim 2, wherein a width of the first grayscale range increases as the degree of dimming of the light source block increases.

10. The display apparatus of claim 1, wherein the local dimmer is configured to determine the degree of dimming of the light source block using a maximum value of a grayscale data in a display block corresponding to the light source block and an average value of the grayscale data in the display block corresponding to the light source block.

11. The display apparatus of claim 1, wherein the luminance compensator comprises a spread part configured to apply an interference value between the light source blocks to the dimming signal based on a light source luminance profile.

12. The display apparatus of claim 11, wherein the luminance compensator further comprises an interpolation part configured to interpolate the degree of the diming of the light source block to which the interference value is applied to generate a dimming value in a unit of a pixel of the display panel.

13. The display apparatus of claim 12, wherein the luminance compensator further comprises a local pixel compensator configured to compensate the luminance of the input image data based on a grayscale value of the input image data in the unit of the pixel and the dimming value in the unit of the pixel.

14. The display apparatus of claim 1, further comprising:
a gate driver configured to output a gate signal to the display panel;
a data driver configured to output a data voltage to the display panel; and
a driving controller configured to control a driving timing of the gate driver and a driving timing of the data driver,
wherein the driving controller comprises the local dimmer and the luminance compensator.

15. The display apparatus of claim 1, further comprising:
a gate driver configured to output a gate signal to the display panel;
a data driver configured to output a data voltage to the display panel;
a driving controller configured to control a driving timing of the gate driver and a driving timing of the data driver; and
a host configured to provide the compensated input image data to the driving controller,
wherein the host comprises the local dimmer and the luminance compensator.

16. A display apparatus comprising:
a local dimmer configured to generate a dimming signal representing a degree of dimming of a light source block based on input image data;
a luminance compensator configured to compensate luminance of the input image data based on the input image data and the dimming signal;
a display panel configured to display an image based on the compensated input image data; and
a light source configured to provide light to the display panel based on the dimming signal,
wherein the local dimmer is configured to generate the dimming signal representing a light source luminance corresponding to a dimming representative value of the light source block in a normal grayscale range and a first light source luminance less than a second light source luminance which corresponds to the dimming representative value of the light source block in a low grayscale range.

17. A method of driving a display apparatus, the method comprises:
generating a dimming signal representing a degree of dimming of a light source block based on input image data;
compensating luminance of the input image data based on the input image data and the dimming signal to generate second input image data;
providing light to a display panel based on the dimming signal;
generating a data voltage based on the second input image data; and
outputting the data voltage to the display panel,
wherein the luminance of the input image data is compensated using a gain varied according to a grayscale value of the input image data.

18. The method of claim 17, wherein the compensating the luminance of the input image data to generate the second input image data comprises:
not compensating the luminance of the input image data in a first grayscale range;
compensating the luminance of the input image data using a fixed gain in a second grayscale range; and
compensating the luminance of the input image data using a varied gain which increases as the grayscale value of the input image data increases in a third grayscale range.

19. The method of claim 18, wherein the third grayscale range is between the first grayscale range and the second grayscale range.

20. The method of claim 18, wherein a gain for the first grayscale range is one,
wherein the fixed gain for the second grayscale range is inversely proportional to the degree of dimming of the light source block, and
wherein the varied gain for the third grayscale range increases from one to the fixed gain for the second grayscale range.
